(19) United States
(12) Patent Application Publication
(10) Pub. No.: US 2026/0296801 A1
(43) Pub. Date: Oct. 1, 2026

(54) METHOD AND SYSTEM FOR RECEIVING AND MANIPULATING ARTICLES

(71) Applicant: Krones Aktiengesellschaft, Neutraubling (DE)

(72) Inventors: Thomas Kiendl, Maxhuette-Haidhof (DE); Martin Kammerl, Hemau (DE); Christian STOIBER, Michelsneukirchen (DE)

(21) Appl. No.: 19/477,287

(22) PCT Filed: Mar. 26, 2024
(86) PCT No.: PCT/EP2024/058129

§ 371 Date: Oct. 21, 2025

(30) Foreign Application Priority Data
Apr. 24, 2023 (DE) 10 2023 110 374.1

(51) Int. Cl. B65G 47/68; B25J 9/00; B65G 47/26; B65G 47/29; B65G 47/90

(52) U.S. Cl. CPC B65G 47/682; B25J 9/0093; B65G 47/261; B65G 47/29; B65G 47/904; B65G 2203/0233

(57) ABSTRACT

A method for receiving and manipulating articles (2, 2′) by at least one industrial robot is disclosed. In the method, articles (2, 2′) are moved along at least one row into a working region of an industrial robot, wherein, in each row, directly consecutive articles (2, 2′) form different relative spacings (20) with respect to one another. A control device (S) is provided, which senses an actual position of each article (2, 2′) by means of at least one sensor system (25) as the article (2, 2′) is moved along the row in question. Furthermore, the control device (S) can control at least one industrial robot according to the sensed actual positions, such that the at least one industrial robot, while or before receiving a plurality of articles (2, 2′) by means of its gripping tool (23), adjusts a relative spacing (20) hitherto formed between said plurality of articles and such that the articles (2, 2′) which the gripping tool (23) of the at least one industrial robot has thereupon received are manipulated in the adjusted relative spacing (20) by the at least one industrial robot.

### CLAIM OF PRIORITY

The present application claims priority to International Application PCT/EP2024/058129 dated Mar. 26, 2024, which in turn claims priority to German Application DE 10 2023 110 374.1 filed Apr. 24, 2023, which are incorporated by reference.

### FIELD OF THE INVENTION

The present invention relates to a method and a system for receiving and manipulating articles.

### BACKGROUND OF THE INVENTION

Switch systems are already known from the prior art that are able to distribute a single-row flow of articles, in which the articles can be formed by drink containers, for example, across several lanes. A disadvantage of such embodiments is that only a single-row article flow can be distributed across several lanes by such a switch. If articles leave several work machines, which can be labeling machines, for example, in several article streams, these several article streams must first be brought together before being distributed by the respective switch. If articles are already aligned in a defined way, this alignment may be lost when merging. For example, articles or containers may have a label and, when leaving a labeling machine, the articles are already placed in a predetermined rotational position with regard to the orientation of the respective label. If the articles are combined, it is possible that the respective label no longer points in the desired direction, and the rotational orientation that was already established is lost again.

A switch is distinguished by the fact that it loads several lanes consecutively with one article each or that it feeds several lanes consecutively with one article each. In practice, this leads to a relatively large gap being formed between successive articles in each lane. In order to close or reduce the gap, the articles are then brought together again in the respective lane by a correspondingly long transport. This also requires an extensive structure of the overall system, which is generally undesirable, in order to be able to achieve an appropriate distribution of articles even with reduced space.

Systems for manipulating articles that use an industrial robot are also known from the prior art. Such systems can be used for distribution, but also for other tasks, such as creating an alignment between a large number of containers that is tailored to a palletizable layer. In such systems, the articles or containers are first stacked so that there is no gap between consecutive articles or containers or so that directly consecutive containers in a respective row are in surface contact with each other. Subsequently, the respective front-positioned article or container is briefly accelerated, and a defined spacing from the following articles or containers is created. In practice, this is done by driving conveyor belts at different transport speeds. In order to achieve such a distribution of articles or containers, even such systems require an extensive structure of the overall system, which leads to increased space requirements. In addition, it is often the case that containers or articles tip over when the defined spacing is established.

An object of the invention can therefore be seen in providing a generic system and a generic method which have the aforementioned disadvantages at least to a reduced extent. The system should also have a simple structure, and the method should be easy to implement.

The object is achieved by the subject matter that comprises the features in the independent claims. Advantageous embodiments are described in the dependent claims.

### SUMMARY OF THE INVENTION

The invention relates to a method for receiving and manipulating articles by at least one industrial robot. In particular, the invention may relate to a method for receiving and manipulating articles in a clamped manner, which are drink containers, by at least one industrial robot.

One step of the method involves moving articles along at least one row into a work area of an industrial robot or into work areas of several industrial robots. In this case, directly consecutive articles in a respective row form different relative spacings from each other. The different relative spacings can be arbitrary. The articles can thus be moved along the respective row without prior alignment with regard to their relative spacing from each other. Thus, it may be that a first relative spacing is formed between a first directly consecutive pair of articles in a row and that a second relative spacing is formed between a further directly consecutive pair of articles. The first relative spacing may be different in size than the second relative spacing.

In various embodiments, exactly one industrial robot can be provided. Embodiments have also proven successful in which exactly two industrial robots are provided, the work areas of which are partially or completely offset from one another with regard to a transport direction of the articles moved along at least one row.

An inlet with at least one horizontal conveyor device can be provided, by which articles are moved along at least one row into a work area of an industrial robot or into work areas of several industrial robots. The at least one horizontal conveyor device can comprise at least one transport belt driven in circulation and/or at least one mat chain driven in circulation, on which the articles stand and are moved along the at least one row into a work area of the one industrial robot or into the work areas of the multiple industrial robots.

The articles may be drink containers, in particular drink bottles and/or drink cans, which in various embodiments may already be combined into a bundle.

A movement of articles along a respective row can be understood as a movement in which all of the articles moved along a respective row are at least partially aligned with one another along their direction of movement or transport. It is thus possible that articles are moved along at least one row into a work area of an industrial robot or into work areas of several industrial robots, wherein directly consecutive articles of a respective row form different relative spacings from one another, and wherein all articles of a respective row are at least partially aligned with one another along their transport or movement direction.

Furthermore, a control device is provided which detects a respective actual position of a respective article by at least one sensor system while the respective article is moved along the respective row. It may be that the control device detects all actual positions of the respective articles of a respective row by the at least one sensor system before the respective articles enter a work area of one industrial robot or the work areas of several industrial robots. The at least one sensor system can be formed by at least one light barrier and/or by at least one camera.

It has proven effective if the control device detects the actual positions of all articles in a respective row, for which purpose all articles in a respective row are moved past at least one sensor system. In such embodiments, the at least one sensor system may be formed by at least one light barrier.

In the invention, it can be that the control device predetermines a defined receiving position, in which the detected actual positions are taken into account, for at least one gripping tool of at least one industrial robot for receiving at least one article, and controls the respective at least one industrial robot so that the respective at least one industrial robot moves its respective gripping tool into the respective predetermined receiving position and receives the at least one article by its gripping tool located in the predetermined receiving position and then manipulates it.

In particular, it may be that the control device predetermines a defined receiving position, in which the detected actual positions are taken into account, for at least one gripping tool of at least one industrial robot for receiving several articles, and controls the respective at least one industrial robot so that the respective at least one industrial robot moves its respective gripping tool into the respective predetermined receiving position and receives the respective several articles by its gripping tool located in the predetermined receiving position and then manipulates them.

This makes it possible for the respective industrial robot to detect articles moved into its work area even if consecutive articles have an arbitrary and previously unfixed relative spacing from each other. Work machines or multiple transport belts with different transport speeds, which in practice have previously been used to initially predetermine a relative spacing of articles before these articles enter the work area of the industrial robot, are no longer necessary. The system therefore has a simple and compact structure.

In addition or as an alternative to this, the control device may be configured to control at least one industrial robot, taking into account the detected actual positions, in such a way that the respective industrial robot, while or before receiving several articles by its respective gripping tool, adjusts a relative spacing hitherto formed between the several articles and manipulates the respective articles, then received by its gripping tool, in the adjusted relative spacing.

It has proven useful in this case if the control device is configured to control at least one industrial robot, taking into account the detected actual positions, in such a way that the respective industrial robot, while or before receiving several articles by its respective gripping tool, adjusts a relative spacing hitherto formed between the several articles in such a way that directly consecutive articles are arranged next to one another and manipulates the respective articles, then received by its gripping tool, in the adjusted relative spacing in which directly consecutive articles are arranged next to one another.

Even in such embodiments, it is not necessary for the relative spacing of articles in a respective row to be adjusted before these articles enter the work area of the respective industrial robot. Such a system can therefore have a simple and compact structure.

It has also proven useful if the control device is configured to control at least one industrial robot, taking into account the detected actual positions, in such a way that the respective industrial robot, while or before receiving several articles, adjusts a relative spacing hitherto formed between these several articles by its respective gripping tool in such a way that a substantially identical spacing is formed between all directly consecutive articles, and wherein the respective industrial robot manipulates the articles then received in this adjusted relative spacing by its gripping tool.

The at least one gripping tool of the at least one industrial robot can be at least two clamping jaws or at least two clamping blocks, which can carry out a common feed movement in order to thereby each receive several articles in a clamping manner. During such a feed movement, the at least two clamping blocks can approach each other or reduce their spacing from each other. In particular, the at least one gripping tool of the at least one industrial robot may comprise at least two clamping jaws or at least two clamping blocks that are aligned parallel to one another.

Embodiments have proven useful in which the control device predetermines a defined receiving position, in which the detected actual positions are taken into account, for at least one gripping tool of the at least one industrial robot for receiving several articles and, in addition, taking the detected actual positions into account, selects a number of the several articles intended for the respective receipt and controls the respective at least one industrial robot, so that the respective at least one industrial robot moves its respective gripping tool into the respective predetermined receiving position and receives the respective several articles with the selected number by its gripping tool located in the predetermined receiving position and then manipulates them.

Alternatively or additionally, the control device may adjust the defined receiving position for the at least one gripping tool of at least one industrial robot to the article intended for the respective receipt, which is arranged last in a transport direction. In particular, it can be provided that the defined receiving position be predetermined in such a way that the article arranged last in the transport direction and the gripping tool are flush or at least approximately flush with each other when the at least one article is received perpendicularly to the transport direction.

It may also be the case that at least one gripping tool of at least one industrial robot comprises a stop by which the respective industrial robot accumulates the respective several articles before receiving the respective several articles, so that the respective several articles are subsequently in surface contact with one another. The articles still in surface contact can then be clamped and subsequently manipulated by the respective at least one gripping tool. The stop can be arranged on a clamping jaw or on a clamping block of the gripping tool.

In addition, the stop can be arranged substantially vertically on a clamping jaw or on a clamping block. It may also be the case that a longitudinal extension of the stop is arranged perpendicularly or substantially perpendicularly to a direction of movement or transport of the respective article arranged in front, which article comes into surface contact with the stop when the relative spacing is adjusted. It is possible that articles still to be received may be delayed beyond the stop to adjust the relative spacing.

It is further conceivable that the at least one industrial robot adjust the respective previously formed relative spacing between the respective several articles by the at least one industrial robot gripping at least one article of the several articles using its gripping tool and accelerating or decelerating it relative to other articles of the respective several articles, subsequently releasing it again, subsequently receiving it together with the remaining several articles, and then manipulating it. In particular, it may be the case that the at least one industrial robot adjusts the respective previously formed relative spacing between the respective several articles by the at least one industrial robot using its gripping tool, which is two advanceable clamping blocks or second advanceable clamping jaws, to grip at least one article of the several articles and to accelerate or decelerate it relative to further articles of the respective several articles.

It is conceivable that articles be moved along several rows into the work areas of a first industrial robot and a second industrial robot, which receive and manipulate articles from the several rows in a coordinated manner. In this case, the first industrial robot may take over the receipt and manipulation of articles for the second industrial robot if the second industrial robot is taken out of service or fails due to a malfunction.

Embodiments have also proven successful in which the at least one industrial robot receives at least one article or several articles at a time and distributes them to different lanes during the manipulation in such a way that each lane of the several lanes is supplied with a predetermined number of articles and in particular that each lane of the several lanes is supplied with a number of articles that remains constant over time. Each lane can be formed by two lane plates oriented parallel to each other, between which articles are guided one after the other along a respective row.

It is conceivable that the predetermined number is selected before the articles are distributed across the multiple lanes and be configured differently for each of the multiple lanes. It may be that each of the several lanes is supplied with a constant number of articles over time.

The number of lanes can be larger than the number of rows along which articles are moved into the work area of one industrial robot or into the work areas of several industrial robots.

In various embodiments, the one industrial robot may be a delta kinematic robot, or the several industrial robots may be delta kinematic robots. For example, the one industrial robot can be a gantry system, or the several industrial robots can be gantry systems.

It is also conceivable that the control device possess information about a particular point in time for the completion of a particular manipulation by the respective gripping tool. In this case, the control device may control the respective industrial robot to move the respective gripping tool at a defined speed in accordance with the detected actual positions, with which the respective industrial robot completes the respective manipulation at the respective time using its respective gripping tool.

The invention also relates to a system for receiving and manipulating articles. The system can be configured to carry out the previously described embodiments of the method according to the invention. In particular, the invention relates to a system for receiving and manipulating articles which are drink containers and preferably drink bottles, drink cans, or drink containers already combined into a respective bundle.

The system comprises an industrial robot with at least one gripping tool or several industrial robots, each with at least one gripping tool.

The at least one gripping tool can be formed by at least two clamping jaws or at least two clamping blocks, which can be actuated with a feed movement to receive at least one article or several articles.

The system further comprises an inlet by which articles moved along at least one row can be moved into a work area of one industrial robot or into the work area of several industrial robots.

The system also includes at least one sensor system. The at least one sensor system can be formed by at least one light barrier and/or by at least one camera and/or by at least one further sensor system. Furthermore, a control device is provided which, with the aid of the at least one sensor system, can detect a respective actual position of a respective article moved in the region of the inlet. A detection range of the at least one sensor system can thus extend over the inlet, so that the control device, with the aid of the at least one sensor system, can detect a respective actual position for all articles moved in the region of the inlet when they pass the detection range of the at least one sensor system.

The control device can be configured to predetermine a defined receiving position for at least one gripping tool of at least one industrial robot, in which defined receiving position the detected actual positions are taken into account. Furthermore, the control device can be configured to control the at least one industrial robot in such a way that the at least one industrial robot thereby moves its respective gripping tool into the respective predetermined receiving position and receives the at least one article by its gripping tool located in the predetermined receiving position and then manipulates it.

Alternatively or additionally, the control device may be configured to control at least one industrial robot, taking into account the detected actual positions, in such a way that the respective industrial robot, while or before receiving several articles by its respective gripping tool, adjusts a relative spacing hitherto formed between these several articles and manipulates the respective articles received by its gripping tool in the adjusted relative spacing.

In various embodiments, the at least one gripping tool of the at least one industrial robot can comprise a stop for accumulating several articles still to be received by the at least one gripping tool. The stop can extend perpendicularly to the longitudinal extent of two clamping jaws through which the respective gripping tool of the respective industrial robot is formed. Alternatively or additionally, the at least one gripping tool of the at least one industrial robot may comprise at least two clamping jaws which can carry out a feed movement for receiving the respective several articles in a clamping manner. The stop can be connected to one of the at least two clamping jaws, so that, during a feed movement of the at least two clamping jaws, the stop is moved along with the clamping jaw to which the stop is connected.

Furthermore, the at least one industrial robot may be formed by at least one delta kinematic robot.

The system may comprise a first industrial robot and a second industrial robot configured to receive and manipulate articles in a coordinated manner in multiple rows. The first industrial robot may be configured and equipped such that the first industrial robot can take over a respective receipt and manipulation of articles intended for the second industrial robot if the second industrial robot is taken out of operation or fails due to a malfunction.

Furthermore, the invention relates to a use of a system according to an exemplary embodiment of the above description for receiving and manipulating articles which are drink containers.

Exemplary embodiments of the invention and their advantages are explained in more detail below with reference to the accompanying figures. The proportions of the individual elements relative to one another in the figures do not always correspond to the actual proportions, since some forms are simplified, while other forms are shown enlarged in relation to other elements for better illustration.

### BRIEF DESCRIPTION OF THE FIGURES

It should be expressly mentioned at this point that all aspects and embodiment variants which have been mentioned in connection with the system according to the invention can also relate to, or be, partial aspects of the method according to the invention. Therefore, if the description or the claim definitions pertaining to the system according to the invention make mention of certain aspects and/or correlations and/or effects, this applies equally to the method according to the invention. The same applies vice versa, so that all aspects and embodiment variants which have been explained in conjunction with the method according to the invention can also relate to, or be, partial aspects of the system according to the invention. Therefore, if the description or the claim definitions pertaining to the method according to the invention make mention of certain aspects and/or correlations and/or effects, this applies equally to the system according to the invention. All structural features which have already been described above for the embodiments of the method according to the invention can also be provided in the embodiments of the system according to the invention.

FIG. 1A illustrates problems and disadvantages of a system already known from the prior art. FIG. 1B shows an embodiment of a system according to the invention and illustrates individual steps as they may be provided in various embodiments of the method according to the invention.

FIG. 2A shows the system already shown in FIG. 1A, which is known from the prior art. FIG. 2B further shows the embodiment of a system corresponding to FIG. 1B and illustrates individual further steps as may be provided in various embodiments of the method according to the invention.

FIG. 3 shows a schematic view of a further embodiment of a system according to the invention and illustrates steps as may be provided in various embodiments of a method according to the invention.

FIG. 4 shows individual aspects as may be provided in various embodiments of a system according to the invention and in the implementation in various embodiments of the method according to the invention.

FIGS. 5A and 5B show a further embodiment of a system according to the invention and illustrate individual steps as may be provided in various embodiments of a method according to the invention.

FIGS. 6A to 6C show a further embodiment of a system according to the invention and illustrate individual steps as may be provided in various embodiments of a method according to the invention.

FIGS. 7A and 7B show the embodiment of the system according to FIGS. 6A and 6B and illustrate further steps as may be provided in various embodiments of a method according to the invention.

FIG. 8 shows a comparison of the speed of an industrial robot with the speed of a horizontal conveyor device.

The corresponding speed can be provided in various embodiments of a system according to the invention, as well as in various embodiments of a method according to the invention.

### DETAILED DESCRIPTION OF THE INVENTION

Identical reference signs are used for identical elements of the invention or those having the same effect. Furthermore, for the sake of clarity, only reference signs are shown in the individual figures which are required for the description of the respective figure. The illustrated embodiments are merely examples of how the invention can be configured, and are non-limiting.

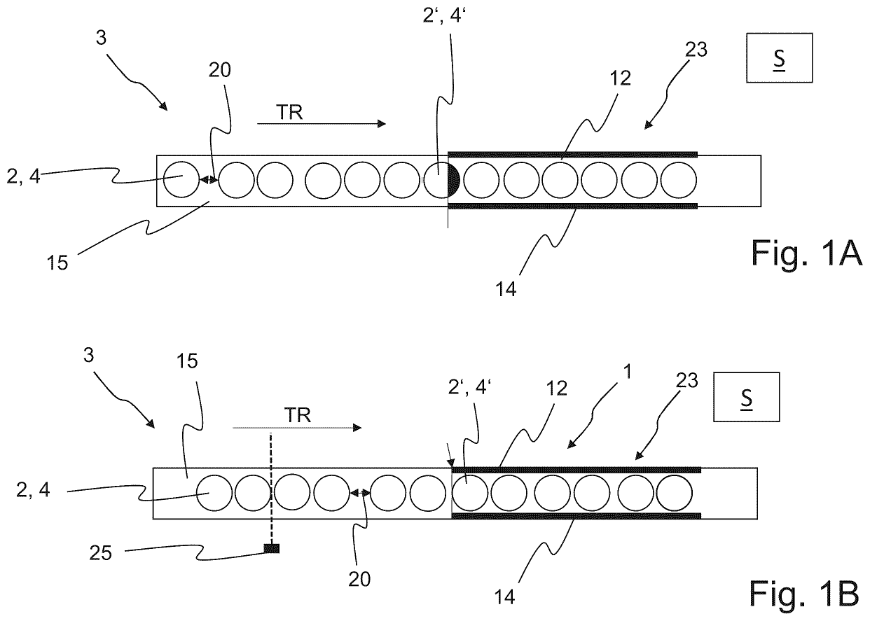

The schematic view of FIG. 1A shows and clarifies disadvantages of systems already known from the prior art and used for distributing articles 2. The articles 2 in this case are drink containers 4. Such drink containers 4 can be formed by drink bottles or drink cans. It is also possible that several such drink containers 4 are already combined into a bundle and manipulated by the system.

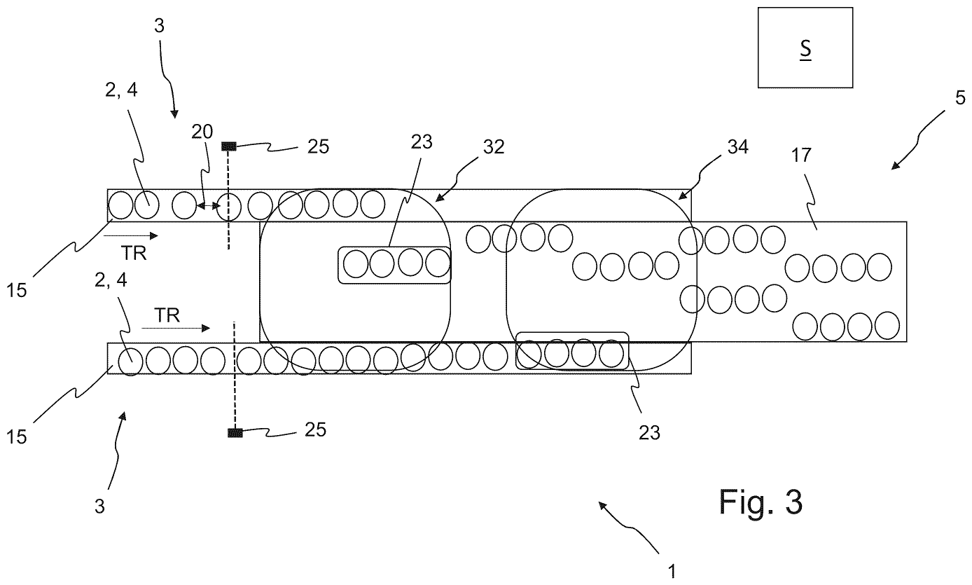

In FIG. 1A, the articles 2 are moved linearly along exactly one row in the transport direction TR by a horizontal conveyor device 15. The articles 2 of exactly one row are aligned in the transport direction TR. As a rule, articles 2 or drink containers 4 first leave a work machine and are then moved by the horizontal conveyor device 15 into a work area 32 or 34 (cf. FIG. 3) of an industrial robot in order to be displaced perpendicularly or obliquely to the transport direction TR by an industrial robot, and thereby reach an orientation in which the articles 2 are aligned with one lane of several lanes. A system that works in this way is called a distribution system. Articles 2 always enter the work area of an industrial robot and are clamped by the industrial robot and distributed across several lanes.

As can also be seen from FIG. 1A, two clamping jaws 12 and 14 are provided in the present case, which are configured as a component of an industrial robot, not shown in FIG. 1A, and can carry out a feed movement in order to receive several articles 2 at least approximately simultaneously and then to move them obliquely or perpendicularly to the transport direction TR. In practice, the clamping jaws 12 and 14 operate in cycles and, after a predetermined period of time, return to a receiving position which is identical for all successive receiving operations of articles 2. In such systems known from the prior art, a movement of the clamping jaws 12 and 14 is coordinated with a transport speed of the horizontal conveyor device 15.

In order to be able to receive articles 2 by the clamping jaws 12 and 14, it is often the case that the articles 2 are brought into a defined relative spacing from one another before being fed to the work area of the industrial robot. This can be done, for example, by first accumulating articles 2 and then predetermining the relative spacing between the articles 2 by feeding the accumulated articles 2 to transport belts with different transport speeds. When the articles 2 reach the work area of the industrial robot, the articles 2 are at least approximately in a position that corresponds to an expected target position, provided that the relative spacing between the articles is adjusted by the preceding transport belts.

In order to bring articles 2 of the row into a defined relative spacing, as is necessary in systems known from the prior art for the secure clamping of several articles 2, such systems have an extensive structure. Thus, it is necessary that a working machine or, as previously mentioned, transport belts be arranged upstream of the horizontal conveyor device 15 in the transport direction TR, which bring the articles 2 into a desired relative spacing from one another.

In FIG. 1A, a problem can be seen which arises when systems known from the prior art do not predetermine the relative spacing of articles 2 before they enter the work area of the industrial robot. In FIG. 1A, arbitrary relative spacings 20, which are not known, are formed between directly consecutive articles 2. For example, it may be that articles 2 leave a labeling station before being transported by the horizontal conveyor device 15 and enter the work area of the industrial robot at any or different relative spacings shown in FIG. 1A. It is also possible that individual articles 2 are rejected due to an error before being fed into the work area of the industrial robot, so that there is a correspondingly large gap between successive articles 2, which corresponds at least to the diameter of an article 2 that has already been rejected.

As shown in FIG. 1A, the last article 2′ held by the clamping jaws 12 and 14 has been only incompletely gripped by the clamping jaws 12 and 14, so that the clamping jaws 12 and 14 cannot apply the necessary clamping force to this article 2, which is required for the subsequent manipulation to securely hold this article 2′. If the articles 2 or 2′ are subsequently moved diagonally or perpendicularly to the transport direction TR by the clamping jaws 12 and 14, it is possible that this last article 2′ will unintentionally detach from the clamping jaws 12 and 14. The distribution of the articles 2 or 2′ across several different lanes must therefore be interrupted.

Practice has shown that the last article 2′ often tips over or falls over if this last article 2′ is gripped incompletely or, as shown in FIG. 1A, by clamping jaws 12 and 14. It is therefore absolutely necessary to dispense with a previously defined specification of the relative spacing 20 between successive articles 2 in apparatuses known from the prior art in order to avoid problems according to FIG. 1A, in which the last article 2′ unintentionally detaches from the clamping jaws 12 and 14.

In FIG. 1B, an embodiment of a system 1 according to the invention can be seen which does not have these disadvantages. The predetermination of a relative spacing 20 of articles 2 is not necessary in the embodiment according to FIG. 1B, so that additional belts or working machines can be dispensed with, which fulfill such a function according to the previous description of FIG. 1A.

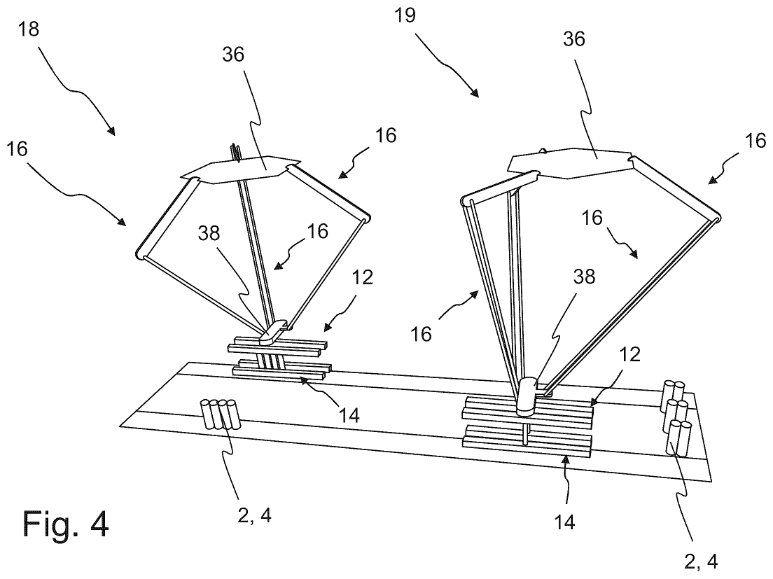

A component of the system 1 is a sensor system 25, which is connected to the control device S and can be configured, for example, as a light barrier, as a camera, or also by another sensor system. All articles 2 of exactly one row are moved past a detection range of the sensor system 25. For each of these articles 2, the control device S can detect the respective actual position by the sensor system 25 when it is moved past the sensor system 25 by the horizontal conveyor device 15. Since the control device S also has information on the transport speed of the horizontal conveyor device 15, the control device S can also determine the position of the article 2 intended for a respective receipt when it has entered a work area 32 or 34 of the industrial robot 18 or 19 (cf. FIG. 4).

As already mentioned in FIG. 1A, in systems known from the prior art, it is provided that the clamping jaws 12 and 14 always be in an identical receiving position when several articles 2 are received successively. A combination of FIGS. 1A and 1B illustrates that the control device S is capable of adjusting or predetermining a respective receiving position of the clamping jaws 12 and 14, so that all articles 2 can be completely clamped, and no received article 2 protrudes beyond the clamping jaws 12 and 14 opposite to the transport direction TR.

According to FIG. 1B, the industrial robot has adjusted the receiving position for the clamping jaws 12 and 14 and offset them with each other in the transport direction TR. FIG. 1B shows that the now last received article 2′ is at least approximately flush with the clamping jaws 12 and 14 and is therefore held firmly between the clamping jaws 12 and 14 when the clamped articles 2 are subsequently displaced obliquely to the transport direction TR.

A comparison of FIG. 1A with FIG. 1B also shows that the clamping jaws 12 and 14 in FIG. 1B have only clamped six articles 2 or 2′, instead of the seven articles 2 or 2′ captured in FIG. 1A. The control device S is therefore also able to select from detected actual positions a number of the multiple articles 2 or 2′ intended for the respective receipt, so that the respective extension of the clamping jaws 12 and 14 in the transport direction TR is sufficient to be able to completely hold all of the respective multiple articles 2 between the clamping jaws 12 and 14 during receipt, without a last article 2′ protruding beyond the clamping jaws 12 and 14 opposite to the transport direction TR.

The embodiment of a system 1 shown as an example in FIG. 1B as well as the steps of the method described in conjunction with the exemplary embodiment have numerous advantages over embodiments known from the prior art. Thus, in a system 1 according to FIG. 1B, no work machines or transport belts are required which bring the articles 2 into an alignment in which the articles 2 have a predetermined and defined relative spacing from one another before being received by an industrial robot. The system 1 therefore has a simple structure. The system 1 is also distinguished by its small space requirement.

Articles 2 also do not need to be slowed down or accelerated before being accepted, in order to create a defined spacing between directly consecutive articles 2. In the system 1 according to FIG. 1B, articles 2 are distributed over several lanes, under gentle handling.

Systems known from the prior art, in which a respective predefined spacing from articles 2 is predetermined before the respective articles 2 enter a work area of an industrial robot, occasionally lead to articles 2 unintentionally tilting or being unintentionally rotated when the relative spacing is predetermined. The risk of unwanted tilting or an unwanted change in a rotational orientation is also lower in the system 1 according to FIG. 1B compared to such systems known from the prior art.

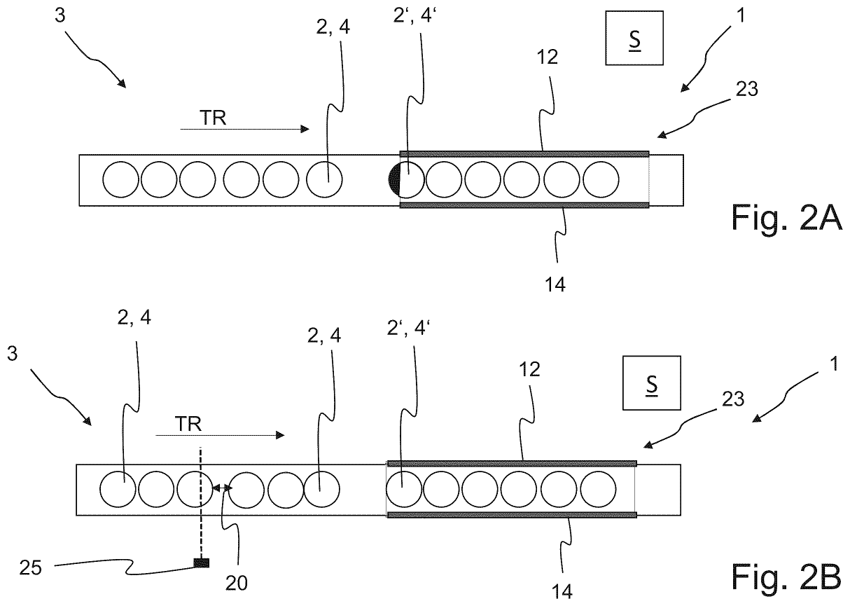

The schematic representation of FIG. 2A shows again the system already shown in FIG. 1A, which is already known from the prior art. The illustration in FIG. 2A illustrates that it may be sufficient for an article 2 to become accidentally released from the clamping jaws 12 and 14 if the last article 2′ extends only slightly beyond the clamping jaws 12 and 14 in the opposite direction to the transport direction TR or if the last article 2′ projects slightly beyond a rear end edge of the clamping jaws 12 and 14.

However, the respective longitudinal extension of the clamping jaws 12 and 14 may, under certain circumstances, be sufficient to clamp the last article 2′ together with the other articles 2 intended for respective receipt, provided the receiving position of the clamping jaws 12 and 14 is adjusted accordingly.

As described in relation to FIG. 1B, the control device S has decided at the position of the last article 2′ according to FIG. 1B that the longitudinal extension of the clamping jaws 12 and 14 is not sufficient to clamp the last article 2′ together with the other articles 2. In contrast, the control device S in FIG. 2B has decided that the longitudinal extension of the clamping jaws 12 and 14 is sufficient to be able to hold the last article 2′ securely between the clamping jaws 12 and 14 with a corresponding adjustment or predetermination of the receiving position of the clamping jaws 12 and 14.

As can be seen from FIG. 2B, the receiving position of the clamping jaws 12 and 14 has been adjusted in each instance by displacing the clamping jaws 12 and 14 slightly opposite to the transport direction TR, and the last article 2′ is thereby at least approximately flush with the clamping jaws 12 and 14 when the several articles 2 or 2′ have been grasped by the clamping jaws 12 and 14. In FIG. 2B, all of the articles 2 intended for clamped receipt could thus still be grasped by the clamping jaws 12 and 14, whereas, in FIG. 1B, the last article 2′ remained on the horizontal conveyor device 15 for later receipt by the clamping jaws 12 and 14, and, in FIG. 1B, therefore only exactly six articles 2 or 2′ have been grasped by the clamping jaws 12 and 14.

FIG. 3 shows a schematic view of a further embodiment of a system 1 according to the invention and illustrates steps as may be provided in various embodiments of a method according to the invention. The system 1 comprises two inlets 3. Via each inlet 3, articles 2, which are further formed by drink containers 4, are moved along exactly one row in the direction of the work areas of industrial robots 18 and 19 (cf. FIG. 4) shown in FIG. 3 with reference to numbers 32 and 34. The industrial robots 18 and 19 are not shown in FIG. 3. The industrial robots 18 and 19 may be delta kinematic robots 28 and 29, as shown in FIG. 4.

Both inlets 3 move the respective articles 2 in the transport direction TR on a horizontal conveyer device 15. The transport directions TR of the inlets 3 are oriented parallel to each other. Each inlet 3 is assigned its own sensor system 25, wherein the sensor systems 25 are connected to the control device S. Via the respective sensor system 25, the control device S is able to detect a respective actual position of articles 2 when the respective articles 2 are moved past the respective sensor system 25 by the respective inlet 3.

If the control device S has detected the respective actual positions of the articles 2 that are to be received by the gripping tools 23 of the industrial robots 18 and 19, the control device S predetermines a respective receiving position for the gripping tools 23 for receiving several articles 2 and controls the respective industrial robot 18 or 19 so that the respective industrial robot 18 or 19 moves its respective gripping tool 23 into the respective receiving position and receives several articles 2 by its respective gripping tool 23, wherein the respective gripping tool 23 is in the respective receiving position.

The gripping tools 23 can be clamping jaws 12 and 14, respectively, as previously shown and described in FIGS. 1B and 2B. The receiving positions can be configured according to the previous description of FIGS. 1B and 2B in order to ensure that no article 2 or no last article 2′ projects beyond the clamping jaws 12 and 14 in the transport direction TR or opposite to the transport direction TR and is thereby held firmly by the clamping jaws 12 and 14 when the industrial robot 18 or 19 manipulates articles 2 or 2′ by the respective gripping tool 23, for example, moving the articles to one or more lanes of a horizontal conveyer device 17 for the outlet 5.

In the embodiment of a system 1 according to FIG. 3, it is provided that the work areas 32 and 34 of the industrial robots 18 and 19 do not overlap. The work areas 32 and 34 of the industrial robots 18 and 19 are offset from each other in the transport direction TR. Furthermore, it can be seen in FIG. 3 that the industrial robot 18 to which the work area shown with reference to number 32 is assigned exclusively accepts articles 2 in a clamping manner, which are made available to this industrial robot 18 by the upper inlet 3 of the two inlets 3. On the other hand, the industrial robot 19 to which the work area shown with reference to number 34 is assigned exclusively accepts articles 2 in a clamping manner, which are made available to this industrial robot 19 by the lower inlet 3 of the two inlets 3.

The industrial robots 18 and 19, to which the work areas 32 and 34 are assigned, are operatively connected to one another by the control device S in such a way that each of the two industrial robots 18 and 19 can take over the tasks of the other industrial robot 18 and 19 if one of the two industrial robots 18 or 19 fails due to a malfunction or has to be temporarily shut down for other reasons.

Via the industrial robots 18 and 19, several articles 2 are each clamped and moved to the horizontal conveyer device 17 in such a way that the respective articles 2 are then aligned with one specific lane from several lanes of the outlet 5. In the present case, exactly four lanes are formed in the region of the outlet 5, into which the articles 2 or the drink containers 4 are distributed in identical numbers. The articles 2 are guided by the outlet 5 towards another work machine, which can, for example, apply packaging to the respective multiple articles 2.

Depending upon the subsequent processing, it may be necessary or useful for one of the lanes to be supplied with a larger number of articles 2 per time unit than the other lanes. The control device S can be able to control the industrial robots 18 and 19 in such a way that a distribution of the articles 2 to the lanes of the outlet 5 is coordinated with a subsequent further processing of the articles 2. For example, a lane can be supplied over a certain period of time with a number of articles 2 that is 10% higher than the number of articles 2 in the other lanes.

A lane (on the horizontal conveyer device 17) in the region of the outlet 5 is formed by a respective pair of lane plates or partition walls which guide the articles 2 in the region of the outlet 5. For reasons of clarity, such lane plates or partition walls are not shown in FIG. 3.

In the embodiment according to FIG. 3, the relative spacing 20 which the respective articles 2 form in the region of the inlet 3 is substantially maintained when the respective articles 2 are clamped by the respective industrial robot 18 or 19, then displaced obliquely to the transport direction TR and moved in the lanes of the outlet 5. This is the case because a transport speed of a horizontal conveyor device 15 configured as a component of the inlet 3 and a transport speed of a horizontal conveyor device 16 configured as a component of the outlet 5 are identical.

However, it may be necessary for subsequent processing of the articles 2 moved by the outlet 5 that there be a small relative spacing or even no relative spacing between successive articles 2. If this is useful or necessary, the control device S can in this case reduce the transport speed of the horizontal conveyor device 16 in order to reduce the relative spacing 20 or even to accumulate articles 2 in the region of the outlet 5 so that successive articles 2 are brought into surface contact with one another in the region of the outlet 5.

In order for the articles 2 to reach the outlet 5 at a predetermined time, the control device S is able to adjust a speed for the respective gripping tool 23 so that a manipulation of the articles 2 or a displacement of the articles 2 obliquely to the transport direction TR is completed at a predetermined time. An increased speed for the respective gripping tool 23 may therefore be necessary if the receiving position for the gripping tool 23 is corrected according to FIG. 1B or FIG. 2B, wherein the gripping tool 23 is displaced opposite to the transport direction TR. A reduced speed for the respective gripping tool 23 may therefore be necessary if the receiving position for the gripping tool 23 is corrected, wherein the gripping tool 23 is displaced in the transport direction TR. The control device S is therefore able, taking into account the detected actual positions of articles 2, to determine a corresponding movement speed for the gripping tool 23 with which an oblique offset to be carried out for article 2 relative to the transport direction TR can be completed at a predetermined time.

Just like the system 1 described in FIGS. 1B and 2B, the system 1 according to FIG. 3 is distinguished by the advantages already mentioned above. In particular, it has a compact structure, since it is not necessary to predetermine the relative spacing 20 between successive articles 2 by transport belts, and the articles 2 can be fed to the work areas 32 and 34 by the respective inlet 3 at any relative spacings 20.

FIG. 4 shows individual aspects as may be provided in various embodiments of a system 1 according to the invention, and in the implementation in various embodiments of the method according to the invention. FIG. 4 shows in particular an exemplary embodiment for two industrial robots 18 and 19, which can be configured as part of an embodiment of a system 1 already described above.

The industrial robots 18 and 19 each have three articulated arms 16, which are attached to a respective robot base 36 and execute a coordinated movement in order to be able to move a gripping tool 23. The gripping tool 23 is arranged on a respective gripper base 38. The industrial robots 18 and 19 are thus configured as delta kinematic robots 28 or 29 and are each connected to the control device S. The respective gripping tool 23 in this case consists of two clamping jaws 12 and 14, which can carry out a respective delivery movement for the clamped receipt of several articles 2.

In alternative embodiments, the gripping tool 23 may also be a pneumatic gripping tool or another gripping tool. It may also be the case that only one of the industrial robots 18 or 19 comprises such a gripping tool 23 that is formed by two clamping jaws 12 and 14, and that another industrial robot 18 or 19 comprises a gripping tool that does not involve such clamping jaws.

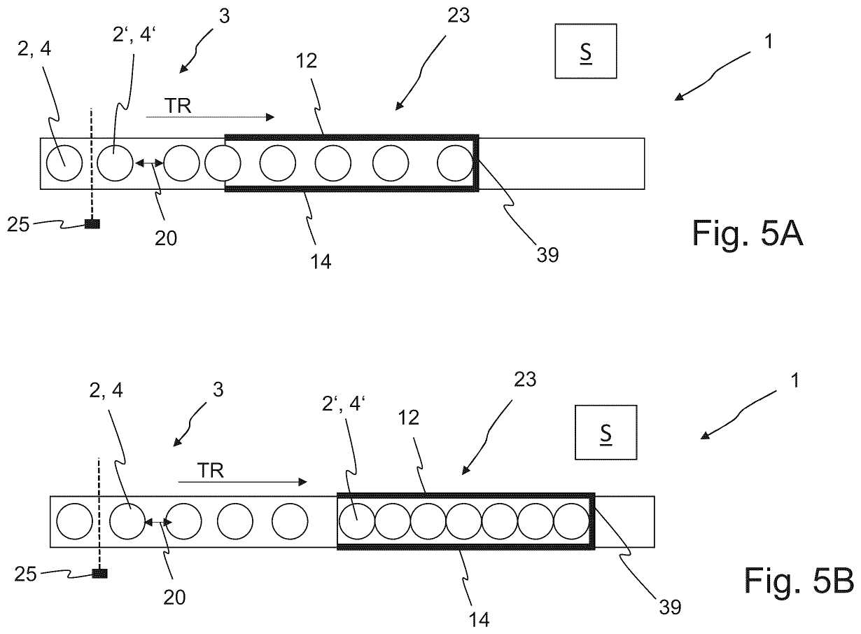

FIGS. 5A and 5B show a further embodiment of a system 1 according to the invention and illustrate individual steps as may be provided in various embodiments of a method according to the invention. In the embodiment of a system 1 according to FIGS. 5A and 5B, a sensor system 25 is also provided which is connected to the control device S. With the aid of the sensor system 25, the control device S can detect the respective actual positions of the articles 2 when they are moved past the sensor system 25. Thus, the control device S is connected to the sensor system 25. In the system 1 according to FIGS. 5A and 5B, the articles 2 are moved along exactly one row in the transport direction TR. However, the system 1 according to the embodiment of FIGS. 5A and 5B is in principle also suitable for receiving articles 2 that are moved along several parallel rows, each in a clamped manner, and for manipulating them accordingly.

The gripping tool 23 of the embodiment according to FIGS. 5A and 5B further comprises two clamping jaws 12 and 14, which can perform a feed movement in order to receive several articles 2 together in a clamping manner. The gripping tool 23 also comprises a stop 39 which is firmly connected to one of the two clamping jaws 12 or 14. A longitudinal extent of the stop 39 is oriented perpendicularly or substantially perpendicularly to the transport direction TR of the inlet 3.

As can be seen from a comparison of FIG. 5A with FIG. 5B, the respective articles 2 intended for clamped receipt are first accumulated by the stop 39 and thereby come into surface contact with a respective article 2 leading in the transport direction TR, until all articles 2 intended for receipt have formed a contact with a respective leading article 2. The control device S can, from the previously detected actual position of the last article 2′ to be received, deduce when this last article 2′ comes into surface contact with the preceding article 2 and in doing so ends at least approximately flush with the two clamping jaws 12 and 14. At this point in time, which is known to the control device S due to the previously detected actual positions, the control device S causes an advancing movement of the clamping jaws 12 and 14, whereby the articles 2 or 2′, which are largely adjacent to one another, are grasped by the clamping jaws 12 and 14.

Following this, the articles 2 or 2′ are displaced obliquely to the transport direction TR and reach a respective orientation in which the articles 2 or 2′ are aligned with a specific lane of several lanes of an outlet 5 (cf. FIG. 3). If, for subsequent processing of the articles 2 already manipulated by the gripping tool 23, it should be necessary that a relative spacing be formed between the articles 2, the outlet 5 can comprise a horizontal conveyor device 16 (cf. FIG. 3) which is operated at an increased transport speed to create a defined relative spacing between successive articles 2.

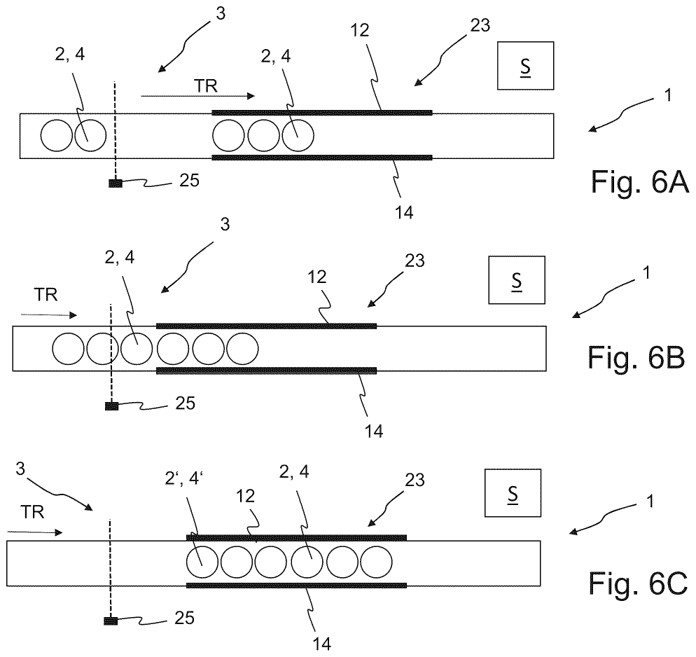

FIGS. 6A to 6C show a further embodiment of a system 1 according to the invention and illustrate individual steps as may be provided in various embodiments of a method according to the invention. In the embodiment according to FIGS. 6A to 6C, the control device S also detects the respective actual position of a respective article 2 by the sensor system 25 when the respective article 2 passes the detection range of the sensor system 25 or when the respective article 2 is moved through the detection range of the sensor system 25.

Taking into account the detected actual positions, the control device S in FIG. 6A has initiated an advancing movement of the clamping jaws 12 and 14, so that exactly three articles 2 are held by the clamping jaws 12 and 14 and are temporarily delayed or even temporarily stand still with respect to subsequent articles 2. The following articles 2 thus approach the exactly three articles 2 held by the clamping jaws 12 and 14. If a leading article 2 of the following articles 2 is in close proximity to the articles 2 held by the clamping jaws 12 and 14 or if a following article 2 even collides with one of the articles 2 held by the clamping jaws 12 and 14, the clamping jaws 12 and 14 are briefly accelerated together with the three held articles 2 until the speed of the held articles 2 corresponds to a speed of the trailing articles 2.

The clamping jaws 12 and 14 are then opened again and brought into a receiving position in which all articles 2 or 2′ intended for receipt are located between the clamping jaws 12 and 14 as shown in FIG. 6C, and a last article 2′ intended for receipt is approximately flush with the clamping jaws 12 and 14. Subsequently, the clamping jaws 12 and 14 are closed again, whereby all articles 2 or 2′ intended for clamped receipt are held by the clamping jaws 12 and 14.

Starting from the position according to FIG. 6C, the gripping tool 23 can now displace the clamped articles 2 obliquely to the transport direction TR and thereby bring them into a position in which these clamped articles 2 are aligned with one specific lane of several lanes of an outlet 5 (cf. FIG. 3).

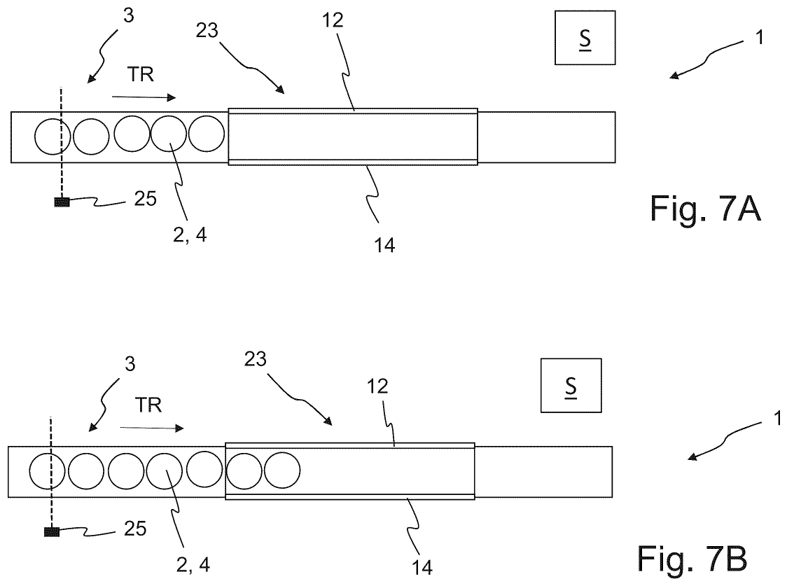

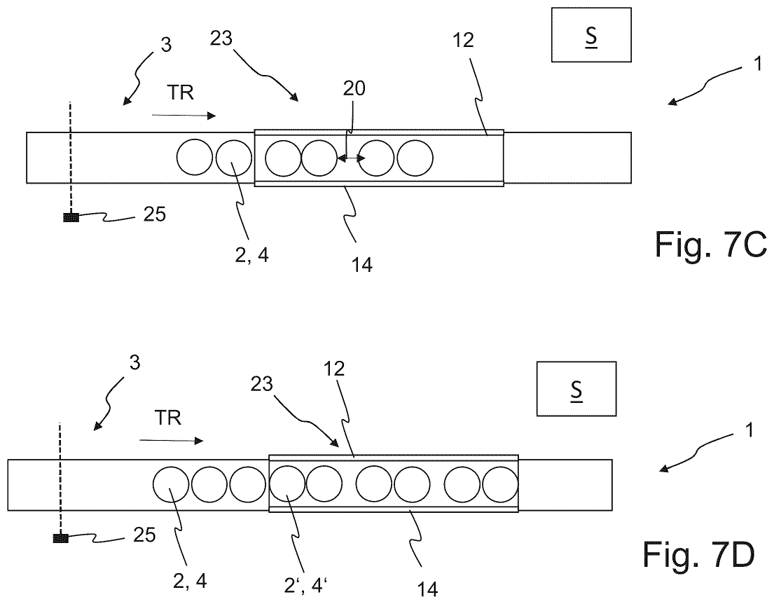

FIGS. 7A to 7D show the embodiment of the system 1 according to FIGS. 6A and 6B and illustrate further steps as may be provided in various embodiments of a method according to the invention. With the system 1, defined relative spacings 20 (cf. FIG. 7C) can be formed between successive articles 2. As already mentioned above, the control device S detects, with the aid of the sensor system 25, the actual positions of all articles 2 when they are moved through the detection range of the sensor system 25.

A comparison of FIG. 7A with FIG. 7B shows that the gripping tool 23 is first moved into a position in which exactly two articles 2 are located between the clamping jaws 12 and 14. The gripping tool 23 then carries out an advancing movement of its clamping jaws 12 and 14, so that exactly two articles 2 are held by the gripping tool 23. The control device S then causes an accelerated movement of these clamped articles 2 in the transport direction TR, whereby a defined relative spacing 20 is formed between the still held articles 2 and subsequent articles 2 (cf. FIG. 7C).

The clamping jaws 12 and 14 are then opened again, and the gripping tool 23 is moved in the direction of further articles 2 to be received. Until two more articles 2 are located between the clamping jaws 12 and 14 as shown in FIG. 7C. The clamping jaws 12 and 14 then carry out another feed movement, whereby they once again grip the two articles 2 already gripped as well as the other articles 2 now arranged between the clamping jaws 12 and 14. The gripping tool 23 also accelerates these further articles 2 relative to trailing articles 2, so that these articles 2 also form a defined relative spacing 20 with respect to trailing articles.

After the clamping jaws 12 and 14 have been opened again, the gripping tool 23 is again moved in the direction of further articles 2 or 2′ to be received, which comprise the last article 2′ to be received (FIG. 7D). By a renewed feed movement of the clamping jaws 12 and 14, these articles 2 or 2′ are also received by the clamping jaws 12 and 14, wherein a last article 2′ ends flush or at least approximately flush with the clamping jaws 12 and 14. The articles 2 or 2′ at the established relative spacings 20 can then be manipulated and brought into an alignment in which the articles 2 or 2′ are aligned with one of several lanes of an outlet 5 (cf. FIG. 3).

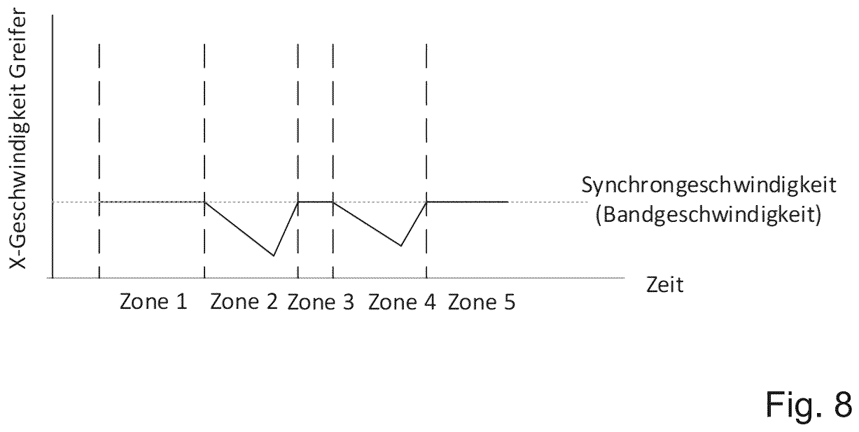

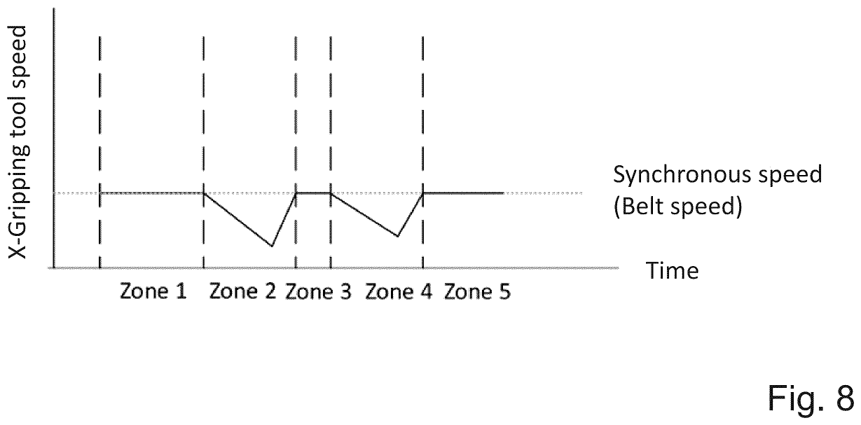

In FIG. 8, a speed of an industrial robot 18 or 19 is compared with a speed of a horizontal conveyor device which moves article 2 when article 2 is located in a work area 32 or 34 (cf. FIG. 3) of the respective industrial robot 18 or 19 (cf. FIG. 4). The corresponding speed can be provided in various embodiments of a system 1 according to the invention, as well as in various embodiments of a method according to the invention.

In zone 1 shown in FIG. 8, a respective industrial robot 18 moves its respective gripping tool 23 at a speed which corresponds to a belt speed of a horizontal conveyor device on which articles 2 stand when they are located in the work area 32 or 34 of the respective industrial robot 18 or 19. When the gripping tool 23 is located in zone 1, clamping jaws 12 and 14 formed as part of the gripping tool 23 carry out a feed movement so that one article 2 or several articles 2 located between the clamping jaws 12 and 14 are gripped by the clamping jaws 12 and 14.

If the gripping tool 23 reaches zone 2, a movement speed of the gripping tool 23 is successively reduced, whereby articles 2, which follow the articles 2 still gripped by the clamping jaws 12 and 14, approach these still gripped articles 2. If the still gripped articles 2 have reached a defined relative spacing to the respective articles 2 that follow the still gripped articles 2, the gripping tool 23 is accelerated in zone 2 so that its movement speed again corresponds to the belt speed. The clamping jaws 12 and 14 in zone 3 are also opened.

In zone 4, the gripping tool 23 is braked again, or a speed of the gripping tool 23 is reduced again compared to the belt speed, so that the articles 2 previously located between the clamping jaws 12 and 14 remain arranged between the clamping jaws 12 and 14, and further articles 2 or 2′ reach between the clamping jaws 12 and 14.

In zone 5, the gripping tool 23 is accelerated, so that its speed corresponds to the belt speed. The clamping jaws 12 and 14 carry out a feed movement in zone 5 and grasp all articles 2 and 2′ arranged between the clamping jaws. A last article 2′ ends flush with the clamping jaws 12 and 14, so that all articles 2 or 2′ arranged between the clamping jaws 12 and 14 are held securely by the clamping jaws 12 and 14 and, opposite to the transport direction TR, do not protrude beyond the clamping jaws 12 and 14.

The invention has been described with reference to a preferred embodiment. However, it is conceivable for a person skilled in the art that modifications or changes can be made to the invention without departing from the scope of protection of the following claims.

### List of Reference Signs

1 system
2 article
2′ last article
3 inlet
4 drink container
4′ last drink container
12 clamping jaw
14 clamping jaw
15 horizontal conveyor device (inlet 3)
16 articulated arm
17 horizontal conveyor device (outlet 5)
18 industrial robot/first industrial robot
19 industrial robot/second industrial robot
20 relative spacing
23 gripping tool
25 sensor system
28 delta kinematic robot
29 delta kinematic robot
32 work area (first industrial robot 18)
34 work area (second industrial robot 19)
36 robot base
38 gripper base
39 stop
S control device
TR transport direction

1. A method for receiving and manipulating articles (2, 2′) by at least one industrial robot (18, 19), comprising:
moving articles (2, 2′) along at least one row of an inlet (3) into a work area (32, 34) of an industrial robot (18, 19) or into work areas (32, 34) of several industrial robots (18, 19), wherein directly consecutive articles (2, 2′) of a respective row form different relative spacings (20) from one another, and
a control device (S) is provided which detects a respective actual position of an article (2, 2′) by at least one sensor system (25) while the respective article (2, 2′) is moved along the respective row, wherein:
the control device (S) defines receiving position for at least one gripping tool (23) of at least one industrial robot (18, 19) for receiving at least one article (2, 2′) and controls the at least one industrial robot (18, 19) so that it moves its at least one gripping tool (23) into the defined receiving position, receives the at least one article (2, 2′) with its gripping tool (23), and then manipulates the at least one article (2, 2′), or wherein:
the control device (S) controls at least one industrial robot (18, 19), taking into account the detected actual positions of the article (2, 2′), to adjust a relative spacing (20) previously formed between several articles (2, 2′) during or before receiving the several articles by gripping tool (23) of the at one industrial robot (18, 19) and manipulates the respective articles (2, 2′), then received by its gripping tool (23), in the adjusted relative spacing (20).

2. The method of claim 1, wherein the control device (S) defines a receiving position for at least one gripping tool (23) of the at least one industrial robot (18, 19) for receiving several articles (2, 2′) selects a number of the several articles (2, 2′) intended for the receipt by the at least one industrial robot (18, 19) and controls the at least one industrial robot (18, 19) so that the at least one industrial robot (18, 19) moves its gripping tool (23) into the defined receiving position and receives the selected number of several articles (2, 2′) by its gripping tool (23) which is located in the defined receiving position, and then manipulates the several articles (2, 2′).

3. The method of claim 2, wherein the control device (S) matches the defined receiving position for the at least one gripping tool (23) of at least one industrial robot (18, 19) to the article (2, 2′) which is arranged last in a transport direction (TR), and wherein the defined receiving position is defined such that the article (2, 2′) arranged last in the transport direction (TR) and the gripping tool (23) are flush or at least approximately flush with one another when the at least one article (2, 2′) is received perpendicular to the transport direction (TR).

4. The method of claim 3, wherein the at least one gripping tool (23) of at least one industrial robot (18, 19) comprises a stop (39) by which the at least one industrial robot (18, 19) accumulates the several articles (2, 2′) before receiving the several articles (2, 2′), so that the several articles (2, 2′) are subsequently in surface contact with one another, whereupon the several articles (2, 2′) still in surface contact are then clamped and subsequently manipulated by the at least one industrial robot (18, 19).

5. The method of claim 4, wherein the at least one industrial robot (18, 19) adjusts the previously formed relative spacing (20) between the several articles (2, 2′) by using its gripping tool (23) to grip at least one article (2, 2′) of the several articles (2, 2′) and accelerates or decelerates the at least one article (2, 2′) relative to further articles (2, 2′) of the several articles (2, 2′), subsequently releases the at least on article (2, 2′) again, subsequently receives the at least on article (2, 2′) together with the remaining several articles (2, 2′), and then manipulates the several articles (2, 2′).

6. The method claim 5, wherein articles (2, 2′) are moved along several rows into work areas (32, 34) of a first industrial robot (18) and a second industrial robot (19), which receive and manipulate articles (2) of the several rows in a coordinated manner, and wherein the first industrial robot (18) takes over the receipt and manipulation of articles (2) for the second industrial robot (19) when the second industrial robot (19) is taken out of operation or fails due to a malfunction.

7. The method claim 6, wherein the at least one industrial robot (18, 19) receives at least one article (2, 2′) or several articles (2, 2′) several times and manipulates them by distributing them to different lanes of an outlet (5) such that each lane of the several lanes is supplied with a predetermined number of articles (2, 2′).

8. The method of claim 7, wherein the predetermined number is selected before distribution of the articles (2, 2′) to the several lanes and is configured differently for the several lanes.

9. The method of claim 7, wherein each lane of the several lanes is supplied with a number of articles (2, 2′) that remains constant over time.

10. The method of claim 1, wherein the at least one industrial robot (18, 19) is a delta kinematic robot (28, 29).

11. The method of claim 1, wherein the control device (S) defines a completion time for completing a manipulation by the at least one industrial robot (18, 19) and wherein the control device (S) controls the at least one industrial robot (18, 19) to move the gripping tool (23) at a defined speed so that the at least one industrial robot (18, 19) completes the manipulation by the completion time.

12. A system (1) for receiving and manipulating articles (2, 2′), comprising
an industrial robot (18, 19) with at least one gripping tool (23) or several industrial robots (18, 19) each with at least one gripping tool (23),
an inlet (3) by which articles (2, 2′) moved along at least one row can be moved into a work area (32, 34) of the one industrial robot (18, 19) or work areas (32, 34) of the several industrial robots (18, 19), and
at least one sensor system (25) and a control device (S) which, with the aid of the at least one sensor system (25), can detect a respective actual position of a respective article (2, 2′) moving in the inlet (3), wherein:
the control device (S) is configured to define a receiving position for at least one gripping tool (23) of at least one industrial robot (18, 19), wherein the detected actual positions are taken into account, and wherein the control device (S) is configured to control the at least one industrial robot (18, 19) in such a way that the at least one industrial robot (18, 19) thereby moves its respective gripping tool (23) into the defined receiving position and receives the at least one article (2, 2′) by its gripping tool (23) located in the defined receiving position and then manipulates it, or wherein;
the control device (S) is configured to control at least one industrial robot (18, 19) to adjust a relative spacing previously established between several articles (2, 2′) by its respective gripping tool (23) during or before receiving several articles (2, 2′) and manipulates the respective articles (2, 2′).

13. The system (1) of claim 12, wherein at least one gripping tool (23) of the at least one industrial robot (18, 19) comprises a stop (39) for accumulating several articles (2, 2′) still to be received by the at least one gripping tool (23).

14. The system (1) of claim 12, wherein the at least one industrial robot (18, 19) is formed by at least one delta kinematic robot (28, 29).

15. The system (1) of 12, wherein the at least one industrial robot *18, 19) comprising a first industrial robot (18) and a second industrial robot (19), which are configured for the coordinated receipt and manipulation of articles (2, 2′) moved in several rows of a inlet (3), wherein the first industrial robot (18) is configured and equipped such that the first industrial robot (18) can take over a respective receipt and manipulation of articles (2, 2′) intended for the second industrial robot (19) if the second industrial robot (19) is taken out of operation or fails due to a malfunction.

16. A use of a system (1) of claim 12, wherein the articles (2, 2′) are drink containers (4, 4′).

17. The method of claim 7, wherein each lane of the several lanes of the outlet (5) is supplied with a number of articles (2, 2′) that remains constant over time.
